(19) United States
(12) Patent Application Publication
(10) Pub. No.: US 2008/0217102 A1
(43) Pub. Date: Sep. 11, 2008

(54) BUILDING EVACUATION DEVICE

(76) Inventor: Reginald S. Armstrong, Huntington Beach, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 11/682,170

(22) Filed: Mar. 5, 2007

(51) Int. Cl. A62B 1/08

(52) U.S. Cl. 182/5; 182/239

(57) ABSTRACT

A building evacuation device is provided for lowering a load (e.g. a person or another object) from a multi-story building to the ground at a controlled rate. The device includes a cable that may be unwound from a spool to allow for the load to be lowered to the ground, where the spool is connected to a rate governor to control the rate at which the cable may unwind and, in turn, the rate at which the load will be lowered to the ground. The unwinding of the cable imparts a corresponding rotational motion on the rate governor, which, in turn, translate such motion to a braking device that imparts a braking force on the rotation of the spool to control the rate at which a person is lowered to the ground.

### TECHNICAL FIELD

This disclosure relates generally to the field of rescue systems for evacuating individuals trapped in multi-story buildings in case of emergency and, more particularly, to a building evacuation device capable of safely lowering individuals to the ground from a multi-story building.

### BACKGROUND

In case of an emergency, such as a fire or earthquake, in a multi-story building, individuals can become trapped and require being rescued from upper level floors in the building. Numerous building evacuation systems exist for multi-story buildings that are designed to evacuate individuals from upper level floors, where such prior evacuations systems have typically incorporated ladders, chutes, slide and the like. A major concern in all such evacuation systems is the reliability of the system and the safety of the evacuees. One major factor in the safety of the evacuees is controlling the rate of descent of the evacuees in such evacuation systems. There is a need for a simple, effective system for evacuating multi-story buildings that safely controls the rate of descent of the evacuees.

### SUMMARY

According to a feature of the disclosure, a building evacuation device is provided for lowering a load from a building at a controlled rate. In one aspect, the building evacuation device can be positioned at a location in a multi-story building to lower the load (e.g, a person or another object) to the ground. For instance, the building evacuation device can be positioned adjacent to a window, on a rooftop or on a building-side of the multi-story building. The building evacuation device may either be mounted to the building itself or may, alternatively, be portable so that it can be moved and positioned at a desirable location in the building when required for use.

In accordance with one feature, the building evacuation device includes a cable wound around a spool having a load attachment mechanism at one end of the cable that is capable of being attached to the load. The cable may be unwound from the spool to allow for the load to be lowered to the ground, where the weight of the load when released from the building will provide the force necessary to unwind the cable from the spool. The spool is connected to a rate governor to control the rate at which the cable may unwind and, in turn, the rate at which the load will be lowered to the ground.

In one embodiment, the rate governor includes a centrifugal or flyball governor having a central drive axle and a plurality of weighted swing arms. The spool is connected to the flyball governor such that the rotation of the spool resulting from the unwinding of the cable will impart a corresponding rotational motion on the central drive axle and, in turn, the weighted swing arms. As the speed of the spool unwinding increases, the central drive axle of the rate governor rotates at a faster rate and the centrifugal force on the weighted swing arms will cause them to move outwards. This outward motion of the weighted swing arms is translated to a braking device connected to the weighted swing arms, where the braking device will impart a braking force on the rotation of the spool to limit its rotational rate. In this manner, the rate at which the cable is unwound from the spool can be controlled.

In one aspect, the building evacuation device includes entirely mechanical components that require no electrical power or human control for their operation in controlling the rate of descent. In another aspect, the building evacuation device is constructed of non-flammable materials capable of withstanding heat associated with a building fire, such that operation of the device is not impaired by a fire and device remains fully functional under emergency conditions.

### DRAWINGS

The above-mentioned features and objects of the present disclosure will become more apparent with reference to the following description taken in conjunction with the accompanying drawings wherein like reference numerals denote like elements and in which:

FIG. 1 is a perspective view of one embodiment of the building evacuation device in use in evacuating a building in accordance with the present disclosure.

FIG. 2 is perspective partial cutaway view of one embodiment of the building evacuation device formed in accordance with the present disclosure.

FIG. 3 is a front partial cutaway view of one embodiment of the building evacuation device formed in accordance with the present disclosure.

FIG. 4 illustrates directional movement of the components of the building evacuation device of FIG. 3.

FIG. 5 is a rear partial cutaway view of one embodiment of the building evacuation device formed in accordance with the present disclosure.

FIG. 6A is a front view of one embodiment of the building evacuation device formed in accordance with the present

FIG. 6B is front view of the building evacuation device of FIG. 6A after opening.

FIG. 7 is a perspective view of a multi-person evacuation embodiment of the building evacuation device in use in evacuating a building in accordance with the present disclosure.

FIG. 8 is a perspective view of an alternative embodiment of the building evacuation device in use in evacuating a building in accordance with the present disclosure.

### DETAILED DESCRIPTION

In the following description, numerous embodiments are set forth in order to provide a thorough understanding of the invention. It will be apparent, however, to one skilled in the art, that these and other embodiments may be practiced without these specific details. In other instances, well-known features have not been described in detail in order not to obscure the invention.

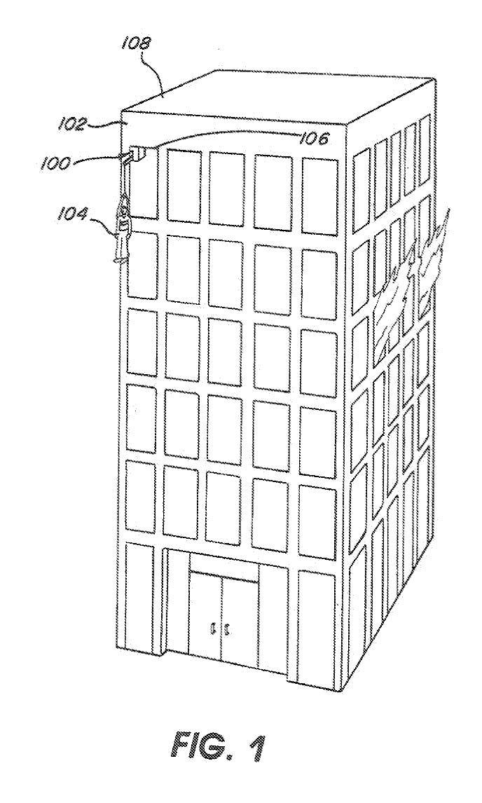

The present disclosure is directed to a building evacuation device that lowers a load at a controlled rate. Referring now to one embodiment of the building evacuation device 100 illustrated in FIG. 1, the building evacuation device 100 can be positioned at a location in a multi-story building 102 to lower a load 104 (e.g, a person or another object) to the ground. As used herein, the term “load” shall refer to a person, multiple people or any object capable of being attached to the building evacuation device 100. The building evacuation device 100 can be positioned in any number of possible locations in a building 102, including, but not limited to, adjacent to a window 106 (as shown in FIG. 1), on the building rooftop 108 or on the side of building 102. The building evacuation device 100 may be mounted to the building 102 or otherwise secured so that it remains in place during use. In an alternative embodiment, the building evacuation device 100 may be portable so that it can be repositioned at a desired location in the building 102 when it is to be used, where the weight of the device 100 may be sufficient to support a load 104 that is being lowered or the device 100 may also be secured in place.

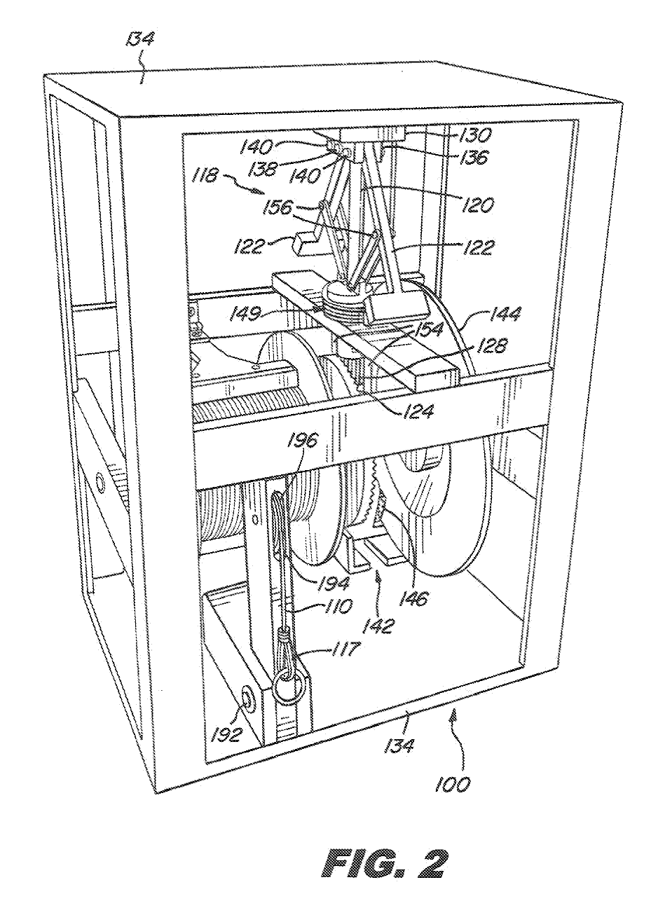

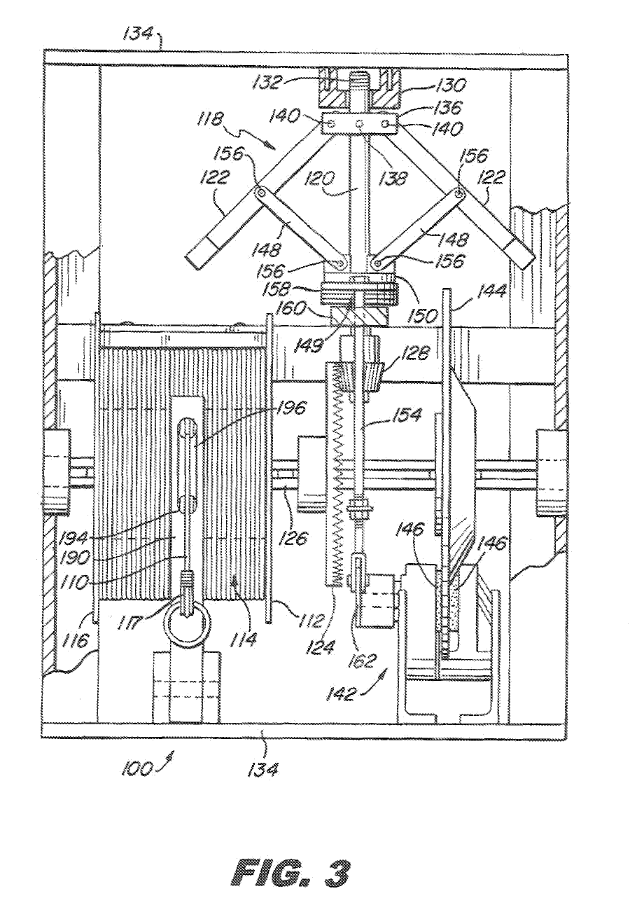

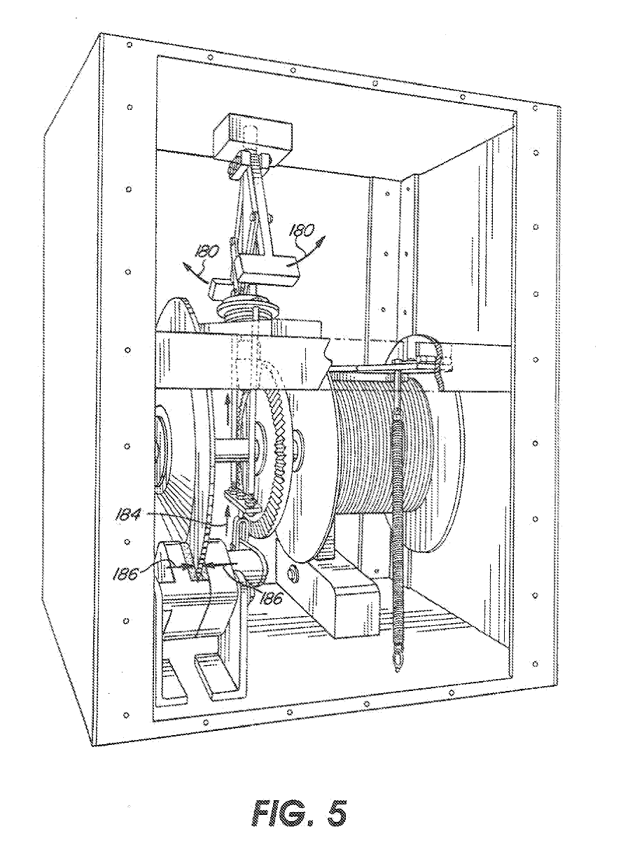

Referring now to FIGS. 2-6, various views of one embodiment of the building evacuation device 100 are provided. The building evacuation device 100 includes a cable 110 wound around a reel or spool 112. The spool 112 includes a cylindrical center section 114 around which the cable 110 is wound and a pair of side plates 116 for retaining the cable on the center section 114. The center section 114 of the spool 112 is mounted about a rotatable central axle 126 that extends between both sides of the device 100. In accordance with one feature of the present disclosure, a load attachment mechanism 117 is located at the end of the cable 110 for connecting a load 104 to the cable 110, where the load attachment mechanism 117 may comprise any type of known cable attachment device that allows a load 104 to be connected to the cable 110. For instance, the load attachment mechanism 117 may comprise a loop formed in the cable 110 as the end of the cable 110 is bent and attached to another portion of the cable 110. In another aspect, the load attachment mechanism 117 may include a ring or hook. In order to support the load 104, a harness, bag, platform, basket or other device is capable of being attached (either removably or permanently) to the load attachment mechanism 117. For example, a harness could be attached to a spring hook or eye hook that could in turn be latched onto the load attachment mechanism 117.

In one embodiment, the building evacuation device 100 includes a davit or arm 190 that pivots about its attachment point 192 to the frame 134 of the device 100. The davit 190 include an opening 194 with a tracked pulley 196 or roller that accommodates the cable 110, such that the cable 110 will roll over the pulley 196 at it is unwound from the spool 112. The davit 190 may be pivoted downward so that it extends outward from the device 100 to provide greater clearance from the side of building 102 for a load 104 that is being lowered.

As a force is applied to the cable 110, the cable 110 may be unwound from the spool 112. In operation, when a load 104 is attached to the cable 110 and the load 104 is permitted to drop from the building (e.g. when the load is a person exiting the window), the force from the weight of the load 104 will cause the cable 110 to unwind to allow for the load 104 to be lowered to the ground. The spool 112 is connected to a rate governor 118 that controls the rate at which the spool 112 may rotate and, in turn, the rate at which the cable 110 may unwind. In this manner, the rate governor 118 controls the rate at which the load 104 will be lowered in order to provide a smooth, consistent rate of descent.

In one embodiment, the rate governor 118 is a type of centrifugal or flyball governor having a drive axle 120 and a plurality of weighted swing arms 122. The spool 112 is mechanically connected to the rate governor 118 such that the rotation of the spool 112 caused by the unwinding of the cable 110 imparts a corresponding rotational motion on the drive axle 120 of the rate governor 118 and, in turn, the weighted swing arms 122. In one embodiment, a gearing arrangement can provide the mechanical connection between the spool 112 and the rate governor 118, where the particular gearing arrangement can be selected based upon a desired relationship between the rotational movement of the spool 112 and the rotational movement of the rate governor 118. For example, the size, type, shape, teeth size and teeth spacing of the gears selected for the gearing arrangement can be variably selected based upon the different cable lowering characteristics required for different types of applications and uses for the building evacuation device 100. The gearing arrangement can also be useful in preventing stop-and-go (e.g, jerky) lowering of the load 104 and encourages a smooth, gradual descent of the load 114.

In one embodiment, the gearing arrangement includes a circular gear 124 having the central axle 126 attached to and extending through its center, where the central axle 126 is further attached to and extends through the rotational axis of the spool 112. Thus, the rotational movement of the spool 112 will be imparted onto the circular gear 124 through the central axle 126. A pinion gear 128 surrounding the drive axle 120 of the rate governor 118 is further attached to the circular gear 124, such that the rotational movement of the circular gear 124 will impart a rotational movement in a different rotational direction in the drive axle 120 based upon the geometry and connection of the pinion gear 128 to the circular gear 124.

In one aspect, the rate governor 118 may include an upper axle mount 130 for supporting an upper end 132 of the drive axle 120 while having an opening that allows the drive axle 120 to rotate therein. The upper axle mount 130 is attached to the frame 134 of the building evacuation device 100 and provides stability for the drive axle 120. The weighted swing arms 122 are attached near the upper end 132 of the drive axle 120 through an attachment 136 that transfers the rotational movement of the drive axle 120 to the swing arms 122. In one embodiment, the attachment 136 is an “H” mount having a central opening for the drive axle 120 to pass there though and further includes at least one pivotal connection 140 that is pivotally connected to a swing arm 122, where there exists a pivotal connection 140 for each respective swing arm 122. The pivotal connection 140 allows the swing arm 122 to rotate about a rotational axis extending through the pivotal connection 140 while still imparting rotational movement from the drive axle 120 to the swing arms 122.

The rate governor 118 further includes a braking device 142 that is connected to the weighted swing arms 122. As the speed of the spool 112 unwinding increases, the drive axle 120 of the rate governor 118 rotates at a faster rate. This rotation is, in turn, imparted on the weighted swing arms 122, where the centrifugal force acting on the weighted swing arms 122 will cause them to move outwards and the pivotal connections 140 will allow the weighted swing arms 122 to pivot upwards. This outward motion of the weighted swing arms 122 is translated to the braking device 142 through their connection, so as to activate the braking device 142. Once activated, the braking device 142 will apply a braking force that slows down the rotational movement of the various components of the building evacuation device 100. By slowing down the rotational movement of such components, the rotational movement of the spool 112 is slowed down thereby reducing the speed at which the cable 110 can be unspooled from the spool 112. In this manner, the braking device 142 serves to control the speed at which the load 104 can be lowered down to the ground.

In one embodiment, the braking device 142 comprises a type of disc brake apparatus including a disc 144 that is also mounted around the central axis 126, such that the disc 144 will rotate in conjunction with the rotation of the central axle 126. Once activated, the braking device 142 will apply a braking force that acts on the disc 144 to slow down its rotation, such as by using a pair of brake pads 146 that are pressed against the side surfaces of the disc 144. By slowing down or resisting the rotational movement of the disc 144, the rotational movement of the central axle 126 and, in turn, the spool 112 are similarly slowed down, thereby reducing the speed at which the cable 110 can be unspooled from the spool 112. In another embodiment, similar braking forces can be applied directly to one of the side plates 116 of the spool 112 if the braking device 142 were connected directly to the side plate 116. In another embodiment, the activation of the braking force by the braking device 142 can also serve to directly impart a resistive force on the rotational movement of the weighted swing arms 122 to slow down their rotational movement. By slowing down the rotational movement of the weighted swing arms 122, the rotational movement of the drive axle 120 and, in turn, the spool 112 are similarly slowed down.

In one embodiment, the weighted swing arms 122 are mechanically connected to the braking device 142 through connector arms 148 that are connected to a flyball governor slide 149. The flyball governor slide 149 includes a connector arm mount 150 for the connector arms 148, a lower axle support 160, and at least one brake linkage rod 154. The connector arms 148 include pivotal connections 156 at both of their ends to allow pivotal movement with respect to both the connected swing arms 122 and the connected connector arm mount 150. The connector arm mount 150 includes an aperture through which the drive axle 120 extends so that the connected arm mount 150 may rotate about the drive axle 120 while also having the ability to move along the axial direction of the drive axle 120. The flyball governor slide 149 also includes a lift plate 158 that does not rotate in conjunction with the connector arm mount 150, but the lift plate 158 and the rest of the flyball governor slide 149 is capable of moving linearly along the axial direction of the drive axle 120. A lower support 160 for the flyball governor slide 149 may be provide to help stabilize the lower portion of the rate governor 118 while also serving to provide a lower stopping point for the flyball governor slide 149 in one axial direction. The flyball governor slide 149 includes at least one brake linkage rod 154, and preferably multiple linkage rods 154, that connect the lift plate 158 to a braking arm 162 of the braking device 142. In this manner, movement of the lift plate 158 will be imparted on the linkage rods 154 and, in turn, the braking arm 162, where the braking arm 162 is arranged to bring the brake pads 146 into frictional contact with the disc 144 to apply the braking force.

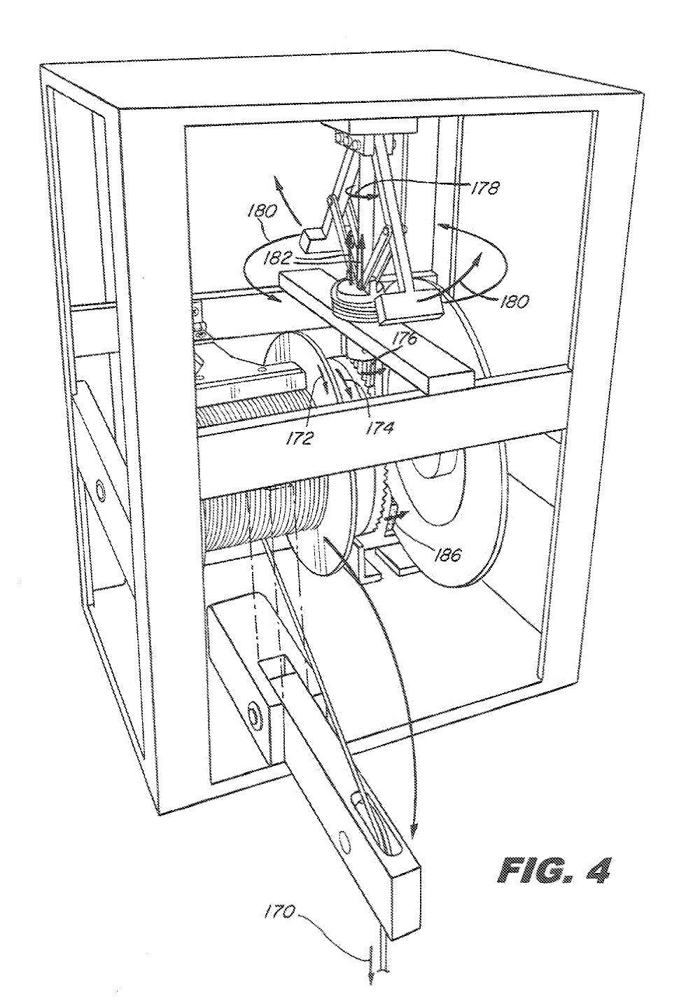

Referring now to FIG. 4, directional arrows are provided to illustrate the movement of the respective components during operation of this embodiment. As the cable 110 is unspooled in direction 170, the spool 112 will rotate in direction 172. This imparts a rotational movement on the gear 124 in rotational direction 174, which, in turn, imparts rotation movements 176 and 178 on the pinion gear 128 and the drive axle 120, respectively. This imparts rotational movement on the weighted swing arms 122, where the centrifugal force acting on the weighted swing arms 122 will cause them to move outwards and pivot upwards in direction 180. This upward movement of the swing arms 122 will pull the connector arm mount 150 upwards along the axial direction of the drive axle 120 along direction 182. This upward movement of the connector arm mount 150 will in turn the entire flyball governor slide 149 upwards, including pulling the lift plate 158 and the brake linkage rods 154 upwards. The upward movement of the brake linkage rods 154 will impart an upward movement of the braking arm 162 along direction 184, which will cause the brake pads 146 to move inward along direction 186 to frictionally engage the disc 144.

The characteristics of the braking device 142 can be selected so as to control the rate at which the cable 110 can be dispensed and, in turn, the load 104 can be lowered to the ground. For instance, the braking device 142 can be arranged such that it is only activated by the rate governor 118 when the cable 110 being dispensed reaches a certain maximum rate, where the braking device 142 can serve to maintain the rate of unspooling of the cable 110 at a constant rate at such maximum rate. With respect to one of the embodiment described herein, the braking device 142 will only be activated when the centrifugal force acting on the weight swing arms 122 is sufficient to lift the braking arm 162 upward. Once activated, the braking device 142 will cause the building evacuation device 100 to lower a load 104 to the ground at a safe, constant rate.

In one embodiment, the constant rate of descent for the load 104 is achieved in a balance that is found between the rate governor 118 and the braking device 142. As the rotational movement of the spool 112 imparts a rotational movement on the weighted swing arms 122 of the rate governor 118, the rate governor 118 translates such rotational movement into a degree of activation of the braking force applied by the braking device 142. The braking force that is applied is directly proportional to the rate of rotation of the weighted swing arms 122. That is, the faster the rotation of the weighted swing arms 122, the greater the braking force that will be applied by the braking device 142. Once the braking force is applied, the rate of rotation of the spool 112 will be reduced, thereby reducing the rate of rotation of the weighted swing arms 122 and, in turn, reducing the degree of activation of the braking device 142. The rate of rotation of the rate governor 118 and the braking force applied by the braking device will thus preferably reach constant values to provide a constant rate of rotation for the spool 112 and a constant rate of descent for the load 104.

In one embodiment, oil light bearings can be situated in various locations in the building evacuation device 100 to frictionally engage rotating metal portions of the device 100. For instance, oil light bearings can be situated in the side mounts of the device 100 where the rotatable central axle 126 is mounted, in the upper axle mount 130 and lower support 160 that support the rotating drive axle 120, in the flyball governor slide 149 (such as adjacent to the rotatable arm mount 150), or in other locations in the device 100. Oil light bearings are types of bearings that are impregnated with oil that are self-lubricating in that they secrete a lubricant such as oil in response to frictional engagement. As such, bearings of this type and other similar self-lubricating bearings can be useful in preventing the various rotating components in the building evacuation device 100 from locking-up or seizing from long periods of non-use. Thus, such self-lubricating bearings allow the building evacuation device 100 to remain dormant or unused for years while still being fully function when ultimately required to be used in case of emergency.

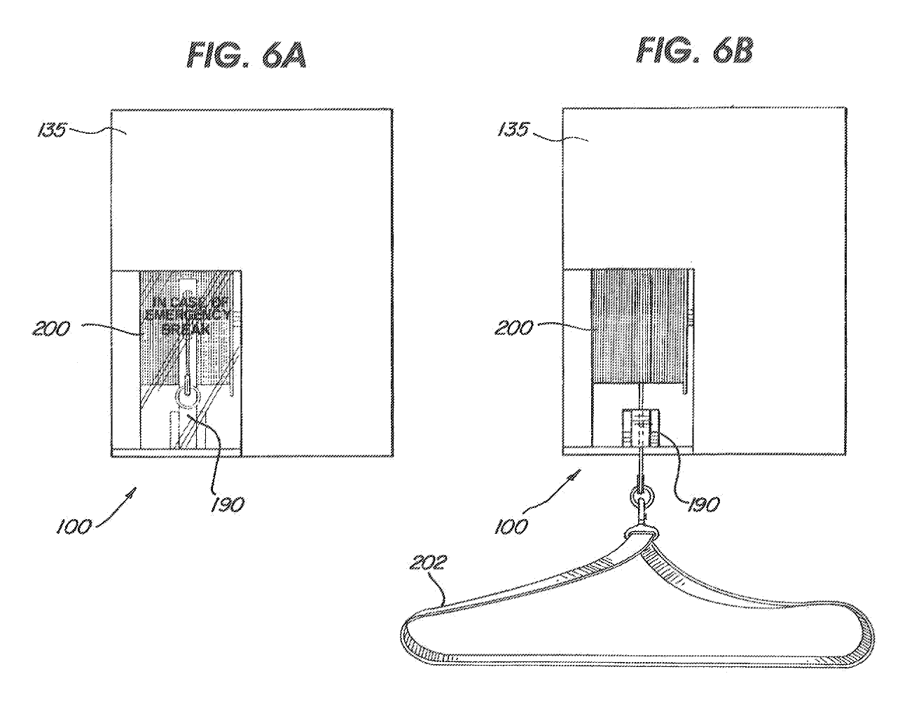

Referring now to FIG. 6A, one embodiment of the building evacuation device 100 is illustrated in its stored, unused condition. An outer skin 135 surrounds the outer frame 134 of the device 100 and substantially encases all sides of the device 100 to shield and protect the inner working components of the device. The building evacuation device 100 is preferably constructed of non-flammable materials capable of withstanding heat associated with a building fire, such that operation of the device is not impaired by a fire and device remains fully functional under emergency conditions. The outer skin 135 and frame 134 may be constructed of aluminum, stainless steel or other durable, weather and heat resistant metal materials or non-metal materials having similar characteristics. In one embodiment, the building evacuation device 100 includes an opening 200 that allows the cable 110 to be unspooled there through and further allows the davit 190 to be pivoted outward from the device 100. The opening 200 may remain open so that a load 104 can be attached to the device 100 when required for an emergency evacuation. Alternatively, the opening 200 can have a removable cover, sliding door, hinged lid, breakable glass or the like that seals the opening 200 when the device 100 is not in use.

Referring now to FIG. 6B, when the building evacuation device 100 is to be used in case or emergency or otherwise, any covering over the opening 200 is removed (if the opening is sealed), and the davit 190 is pivoted downward into its lower operating position. As described above, the davit 190 serves to provide additional clearance from the building for the lowering of the load 104. In one embodiment, a harness 202 will be pre-attached to the load attachment mechanism 118 on the end of the cable 110, so that a person intending to use the building evacuation device 100 can simply place the harness 202 around their body and then let themselves be lowered down to the ground automatically by the device 100. Harnesses, such as harness 202, are known in the safety rescue field to be able to securely and safely lower an individual(s) when positioned under the armpits of the individual(s) with little to no possibility of the individual(s) slipping through the harness 202. Thus, once a person puts the harness 202 around his body and secures the harness 202 in place, the person simply needs to let themselves be supported by the device 100 and let gravity supply the requisite force to begin the unspooling the cable 110. The building evacuation device 100 will then lower the person or any other connected load 104 at a controlled rate without requiring any additional human intervention or control and further without requiring any powered electronics or power devices to sustain the controlled rate. In one embodiment, the building evacuation device 100 allows a load 104 to descend to the ground at a controlled rate of approximately 2 feet per second regardless of the weight of the load 104 or the height from which the load 104 is descending. Other types of possible attachment mechanisms can be utilized in place of harness 202 for securing a load 104 to the device 100, where different types of attachment mechanisms can be utilized for different types of loads 104.

As such, the building evacuation device 100 is intended to make evacuation of a multi-story building 102 a simple and efficient process that does not require any additional effort or thought by a person other than simply placing a harness 202 around themselves and letting themselves be lowered to the ground. Further, the building evacuation device 100 of the present disclosure requires little or no maintenance, as all of the components of the device 100 are capable of functioning in their intended manner, even after being stored for long periods of time. The components are constructed of materials that are fire resistant, weather resistant and otherwise resistant to corrosion from the surrounding environment.

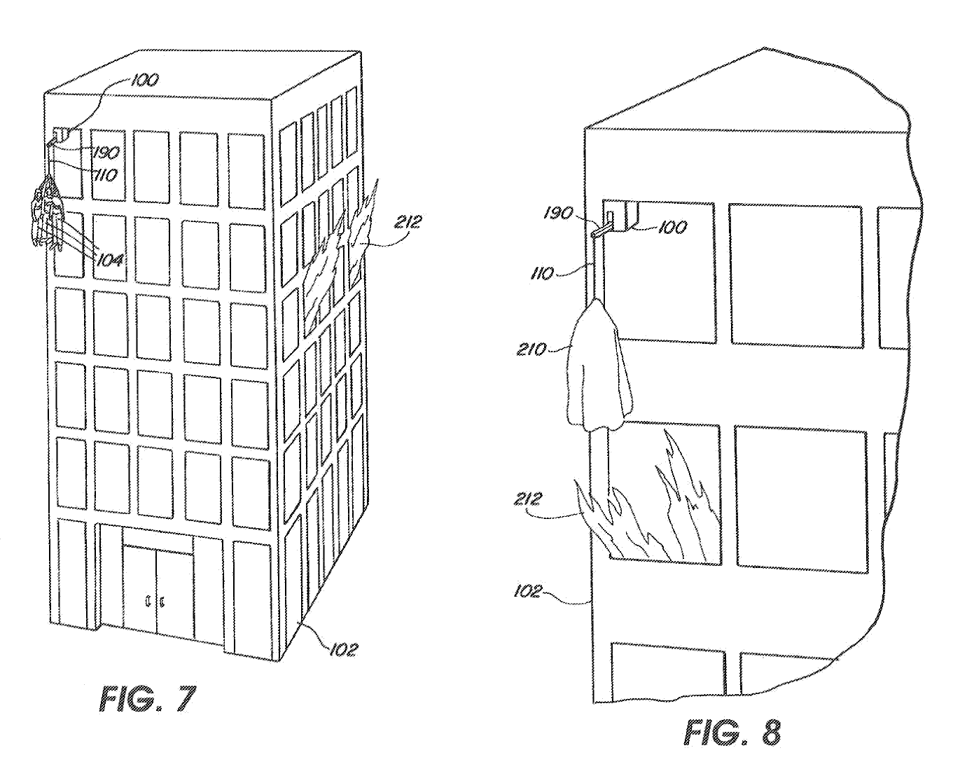

In one embodiment, multiple loads 104 are capable of being attached to the building evacuation device 100 and lowered to the ground, as illustrated in FIG. 7. For instance, a plurality of harnesses 202 could be pre-attached to the load attachment mechanism 118 on the end of the cable 110, so that multiple people intending to use the building evacuation device 100 can simply place the harness 202 around their bodies and then let themselves be lowered down to the ground automatically by the device 100. The operation of the building evacuation device 100 in lowering the load 104 to the ground at a controlled rate is the same whether one person or a plurality of people are lowered to the ground, where the weight of the load 104 will not significantly impact the operation of the device 100. The particular material, gauge and length selected for the cable 110 should be selected based on the height at which the building evacuation device 100 will be utilized and the intended maximum weight for the load 104 to be lowered. In one embodiment, the cable 110 may comprise a length of ⅛″ galvanized wire rope or plow steel cable. Loads 104 up to and exceeding 1,000 pounds could be safely lowered using the building evacuation device 100.

In another embodiment, the building evacuation device 100 may include a protective covering 210 that can be used to cover the load 104 that is being lowered to the ground. The protective covering 210 should be constructed of a material resistant to flames, fire, heat and/or other elements that protect the load 104 as it may be exposed to fire as it passes by a burning window 212 when being lowered to the ground. One example of such material is the material used to construct fire blankets and the like used by fire fighters. The protective covering 210 can be formed as a bag-like structure that the load 104 is inserted within and the protective covering 210 around. By completely surrounding the load 104, the load 104 would not only be protected from the flames of a burning building but would also be shielded from noxious fumes and smoke.

The building evacuation device 100 will be described throughout the present disclosure as being used to evacuate people from a multi-story building in case of emergency, such as a fire. However, it is understood that the building evacuation device 100 could also be attached to other vehicles or objects, other than buildings, for safely lowering a person from one height to a lower height. For instance, the building evacuation device 100 could be attached to rescue vehicle, such as a fire engine or the telescoping platform on the fire engine, a helicopter, shipping vessel, etc. In a portable aspect, the building evacuation device 100 could be fastened to an object near the top of a cliff, ravine or the like to rescue a person trapped below. In still further aspects, the building evacuation device 100 could be used in non-emergency situations where it is simply necessary to lower a load from a raised height to the ground using the controlled descent provided to a load by the building evacuation device 100.

While the system and method have been described in terms of what are presently considered to be specific embodiments, the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A building evacuation device, comprising:
a cable wound around a rotatable spool;
a rate governor connected the spool such that rotational movement of the spool imparts a rotational movement on the rate governor; and
a braking device activated by the rotational movement of the rate governor to apply a braking force on the rotational movement of the spool.

2. The building evacuation device of claim 1, further comprising a load attachment mechanism on an end of the cable capable of attaching a load to the cable.

3. The building evacuation device of claim 1, wherein the rate governor is a flyball governor.

4. The building evacuation device of claim 1, wherein the braking device is a disc brake.

5. The building evacuation device of claim 4, wherein the disc brake includes a disc mounted on a rotatable axle that is further connected to the spool, wherein the braking force is applied to the disc to control the rotation of the rotatable axle and in turn the rotation of the spool.

6. The building evacuation device of claim 1, wherein the rate governor and braking device control the rate at which the cable can be unwound from the spool.

7. The building evacuation device of claim 1, wherein the device does not include any components requiring electrical power.

8. The building evacuation device of claim 1, further comprising a gearing mechanism for transferring rotational movement from the spool to the rate governor.

9. The building evacuation device of claim 1, further comprising multiple attachment mechanisms for attaching multiple loads to the end of the cable.

10. The building evacuation device of claim 1, further comprising a fire resistant covering capable of being extended around a load to be lowered by the device.
